(19) United States
(12) Patent Application Publication
(10) Pub. No.: US 2004/0267527 A1
(43) Pub. Date: Dec. 30, 2004

(54) Voice-to-text reduction for real time IM/chat/SMS

(75) Inventors: Thomas E. Creamer, Boca Raton, FL (US); Peeyush Jaiswal, Boca Raton, FL (US); Christopher J. Pavlovski, Westlake (AU)

Correspondence Address: AKERMAN SENTERFITT, P. O. BOX 3188, WEST PALM BEACH, FL, 33402-3188, US

(73) Assignee: International Business Machines Corporation, Armonk, NY

(21) Appl. No.: 10/603,495

(22) Filed: Jun. 25, 2003

(51) Int. Cl. G10L 15/00

(52) U.S. Cl. 704/235

(57) ABSTRACT

A method or system (40 or 50) for voice-to-text reduction for real-time messaging can use a microphone (12 or 52) for receiving a calling party's speech input, a text-to-speech converter (22 or 54) for converting the calling party's speech input to a text message, a transmitter for transmitting the text message as a text stream (23 or 60) to a called party, a receiver for receiving another text message as a text stream (31 or 70) from the called party, and a rendering device such as a speaker (36) or a display (68) for rendering text messages substantially in real-time. If a speaker is used, the system can further include a text-to-speech synthesizer or converter (24). A system (80) can further include a translator (82) for translating the text message into another language.

### BACKGROUND OF THE INVENTION

1. Technical Field

This invention relates to the field of telecommunications and more particularly to real time messaging using voice-to-text reduction.

2. Description of the Related Art

Current on-line systems for real-time exchange of text messages (i.e., online chat) are hindered by current user input technologies. Keyboards, keypads and mice can be eliminated if only voice or speech interfaces could overcome the issues in voice transcription and transmission efficiency. Current messaging systems that have a voice component as an input are subject to numerous problems that become evident in low bandwidth environments and in devices that either have poor input or poor output capabilities. For example, current mobile phones are subject to all the problems described above (low bandwidth network, poor text input, and poor visual display).

Examples of known systems using text-to-speech and speech-to-text include U.S. Patent Publication US2002/0069069 A1, where such system focuses on communications between participants that can and cannot hear voice conversations, or U.S. Pat. No. 6,339,754 B1, where text-to-speech and speech-to-text technologies coupled with language translation enable chat and voice conferencing, or U.S. Pat. Nos. 6,385,586 B1 or 6,292,769 B1, where text-to-speech and speech-to-text technologies are used to improve language translation between two or more spoken (different language) communications.

Although there are numerous systems using text-to-speech and speech-to-text technologies, none are ideally suited for augmenting voice (and text) chat over data transmission protocols, wherein such protocols can include chat/instant messaging (IM) and messaging protocols such as SMS. None of the existing systems combine several disparate transmission protocols with a plurality of system, transmission and language conversions to augment voice or text chat over data transmission protocols. Thus, a need exists for a system and method that can overcome the detriments described above.

### SUMMARY OF THE INVENTION

Embodiments in accordance with the invention can include a new technique for providing a real-time chat channel. Such embodiments can deploy Speech-to-Text transcription and Text-to-Speech synthesis for real-time exchange of text messages (i.e. online chat). This can solve several problems, including improvements in voice transmission efficiency (in the order of 90% improvement) and elimination of keypad and keyboard devices for on-line chat. The ability to conduct an on-line chat session over mobile phone is currently not practical. As such, embodiments in accordance with the invention enable two parties to conduct an on-line chat session on mobile phones for example by overcoming the limitations of these devices. This has many potential applications that extend beyond mobile phones, and is particularly suited to several environments that exhibit the following restrictions:

1. Low bandwidth environments.

2. Devices that have poor input capabilities.

3. Devices that have poor output capabilities.

As suggested, one application of the invention is the use of real-time chat over mobile phones. Present day mobile devices have to deal with all three problems listed above (low bandwidth network, poor text input, and poor visual display). More specifically, the embodiments in accordance with the invention can utilize voice input-output with text compression and voice input transcription for real-time chat to overcome the limitations described above. In addition, other embodiments of the invention can be used to provide a language translation function between two parties. Hence, additional applications can include Voice Input-Output with Language translation and Voice Input transcription with language translation.

In a first aspect of the invention, a method of voice-to-text reduction for real-time messaging can include the steps of receiving a speech input at a calling party, transcribing the speech input to a text message, transmitting the text message as a text stream to a called party, receiving a text message from the called party as a text stream, and rendering the text stream at the called party and the calling party substantially in real-time. The rendering step can include either displaying the text message or providing an audible output using a speaker and text-to-speech conversion or synthesis. The method can further include, as mentioned above, a translation step, where the text message is translated to another language either at the calling party, the called party, or at a server in-between.

In a second aspect of the invention, a system for voice-to-text reduction for real-time messaging can include a microphone for receiving a calling party's speech input, a text-to-speech converter for converting the calling party's speech input to a text message, a transmitter for transmitting the text message as a text stream to a called party, a receiver for receiving another text message from the called party, and a rendering device for rendering text messages substantially in real-time.

In a third aspect of the invention, a computer program has a plurality of code sections executable by a machine for causing the machine to perform certain steps. The steps can include the steps of receiving a speech input at a calling party, transcribing the speech input to a text message, transmitting the text message as a text stream to a called party, receiving a text message from the called party as a text stream, and rendering the text stream at the called party and the calling party substantially in real-time. The step of rendering can include the step of converting the text message at the called party to a speech output by using text-to-speech conversion in conjunction with a voice signature of the calling party.

### BRIEF DESCRIPTION OF THE DRAWINGS

There are shown in the drawings embodiments which are presently preferred, it being understood, however, that the invention is not limited to the precise arrangements and instrumentalities shown.

FIG. 1 is a flow diagram illustrating an exemplary telecommunications system illustrating voice signature capture and voice-to-text compression in accordance with the inventive arrangements disclosed herein.

FIG. 2 is a flow diagram illustrating a method of voice-to-text compression according to the present invention.

FIG. 3 is another flow diagram illustrating a method of voice-to-text conversion in accordance with the inventive arrangements disclosed herein.

FIG. 4 is yet another flow diagram illustrating a method of voice-to-text compression with language translation in accordance with the present invention.

FIG. 5 is a flow diagram illustrating a method of voice transcription for real-time chat with language translation in accordance with the present invention.

### DETAILED DESCRIPTION OF THE INVENTION

Embodiments in accordance with the invention can provide a solution for applications that go well beyond previous inventions that propose the use of speech transcription technologies as a command interface only. Furthermore, present day speech to text (transcription) and text to speech (using an appropriate synthesis algorithm) technologies can be applied to embody the proposed invention in a technically feasible manner.

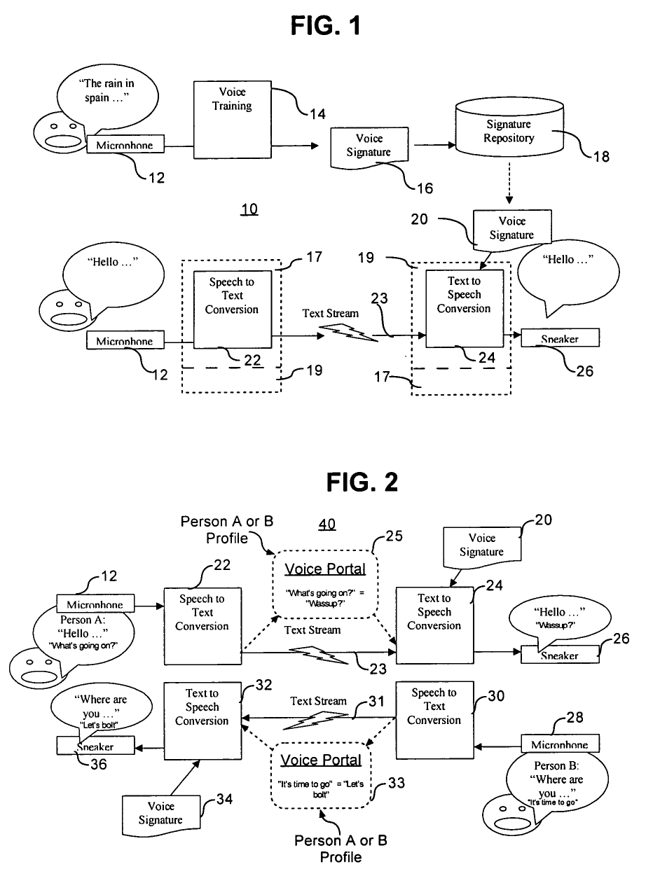

The techniques described herein significantly reduce the bandwidth requirements in communication systems by using and extending the Voice-to-Text Compression benefit outlined. The compression benefit is achieved when compared to the conventional transmission of a voice signals that are compressed using techniques such as Codec voice encoding. Referring to FIG. 1, a system 10 in accordance with the invention has the calling or sending party voice transmission converted to text, (this can be achieved using present day transcription techniques). The text (which can be further compressed) is then transmitted to the receiver or called party, and at the receiving end the text stream is then converted to speech. To reconstruct the original voice of the calling or sending party a previously recorded voice signature 16 is applied during the text-to-speech synthesis conversion at the receiver. This process is able to achieve over a 90% compression improvement over the conventional Codec approaches. It has been suggested that the error rate of entering text is in the order of 10-20%. Using present day technologies (such as Via voice, and text-to-speech synthesis techniques) a similar error rate can be achieved, without the need for the user to enter text mechanically.

The proposed embodiments can be fundamentally extended in two ways. The first approach enables two parties to conduct a voice enhanced on-line chat session. The diagram of FIG. 1 illustrates how the sending party's voice transmission is converted into a text stream (using transcription technologies). The text stream is then forwarded onto the receiving party. At the receiving end, the text stream is converted back to a voice stream using the previously recorded voice signature of the sending party as will be further detailed below. As such the reconstructed signal is formed in the voice print of the sending party.

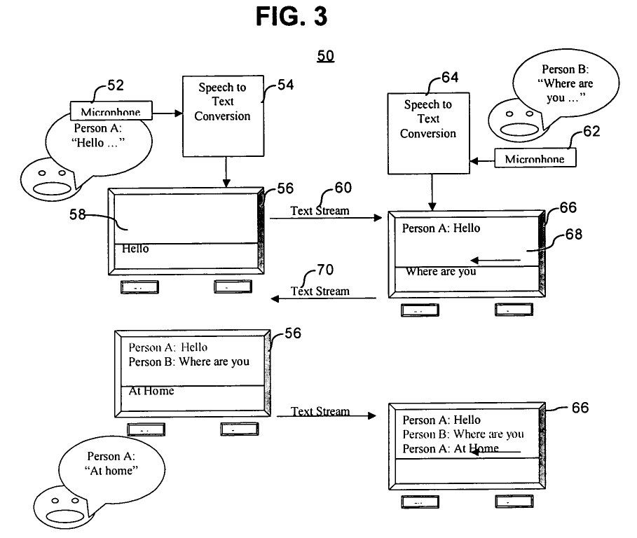

An alternative extension is the use of voice transcription for entering text into an online chat session, most notably over a mobile phone. Such extension will be further explained with reference to FIG. 3, but in summary, the sender's voice is converted into a text stream, overcoming the device input restriction of small devices. The text stream is then forwarded onto the receiver as in the normal on-line chat scenario. In reply, the receiver would also have their voice transmission converted into the reply text.

Referring once again to FIG. 1, the system 10 for voice-to-text reduction for real-time messaging can use a microphone 12 for receiving a calling party's speech input, a text-to-speech converter 22 for converting the calling party's speech input to a text message, a transmitter 17 for transmitting the text message as a text stream 23 to a called party, a receiver 19 for receiving another text message as a text stream 31 (as shown in FIG. 2) from the called party, and a rendering device such as a speaker 26 or a display 68 (as shown in FIG. 3) for rendering text messages substantially in real-time. If a speaker is used, the system can further include a text-to-speech synthesizer or converter 24. Note that the transmitter 17 and receiver 19 can be a part of a transceiver having a speech-to-text converter in the transmitter portion and a text-to-speech converter in the receiver portion as shown.

Operationally, a user of the system 10 would preferably use their microphone 12 to initially use a voice training module 14 to create a voice signature to be stored in a signature repository 18. As explained above, the voice signature 18 or a copy 20 of the voice signature is retrieved from the signature repository 18 to reconstruct the original voice of the calling or sending party. Thus, a voice input such as “hello” provided by the calling party into the microphone 12 is converted to a text message using the text-to-speech converter 22 and sent as a text stream to the receiver 19 and a text-to-speech synthesizer 24. The previously recorded voice signature (16 or 20) is applied during the text-to-speech synthesis conversion at the receiver 19 so that “hello” is audibly detected at the speaker 26 with a voice resembling the calling party's voice.

Referring to FIG. 2, a system 40 illustrates the interaction between two parties in a full duplex mode using a system as described in FIG. 1. Operationally, a user (such as Person A) of the system 40 would preferably use their microphone 12 to provide a voice input such as “hello . . . what's going on?” which is converted to a text message using the text-to-speech converter 22 and sent as a text stream 23 to a receiver having a text-to-speech synthesizer 24 as previously described. Optionally, a voice portal 25 can exist on a remote server having a profile for a particular user (Person A or B) that enables such users to convert selected text to alternative text. For example, the text phrase “what's going on?” can be converted to the alternative slang text phrase “wassup?”. It should be noted that the signature repository and the voice portal can be co-located on the same server. Thus, Person B having the speaker 26 would hear the inputted text “Hello . . . what's going on?” as “Hello . . . wassup?”. Likewise, Person B can provide a voice input of “Where are you . . . it's time to go” at a microphone 28. This phrase can be converted to text using speech-to-text converter 30 to provide a text stream 31 back to Person A. The text stream 31 can be converted to speech using the text-to-speech converter 32 and voice signature 34 so that the audible speech at speaker 36 resembles the voice of Person B. As before, the text stream 31 can optionally use a voice portal 33 to convert the existing text to alternative text. In this example, the phrase “it's time to go” can be recognized by the voice portal and converted to an alternative phrase such as “Let's bolt.” Thus, the original Person B input will be heard as “Where are you . . . Let's bolt” at Person A's speaker 36. Applying the voice signature 34 during the text-to-speech synthesis conversion (32) enables Person A to audibly hear Person B's text message with a voice resembling the calling party's (Person B's) voice. Several benefits are apparent with this approach including the compression of the voice stream to a text stream, requiring a lower transmission bandwidth and hence lower cost for the delivery, overcoming device input capability, and overcoming device output capabilities.

Referring to FIG. 3, a flow diagram is shown of system 50 for voice input transcription for real time chat. In this embodiment, a calling party such as Person A would provide a voice input such as “hello” to a microphone which is subsequently converted to text using a speech-to-text converter 54. If a computing device 56 (such as a mobile phone, personal digital assistant or computer) has a display 58, then Person A's voice input can optionally be seen as shown. The text can then be transmitted as a text stream 60 to a computing device 66 (similar to 56, but not necessarily) wherein the text “hello” will appear on a display 68 of device 66. Person B or the called party can respond by providing speech input to a microphone 62 which is converted to text using a speech to text converter 64. Person B's speech-to-text converted input can be displayed on the display 68 on any form of interface, but preferably one suitable for chat/IM as shown.

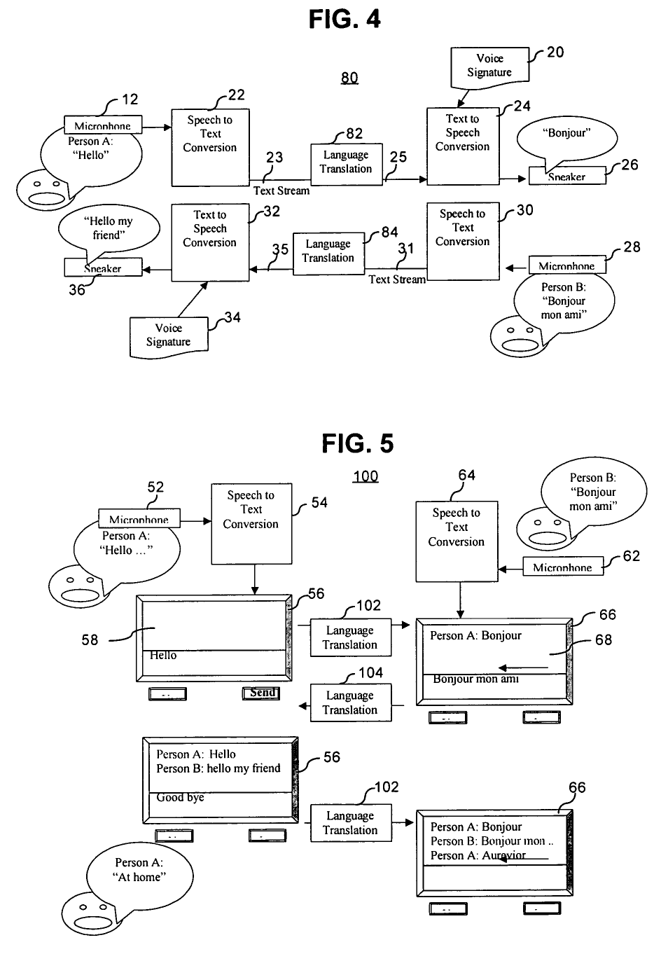

Another extension of the concepts herein can provide real-time language translation. Real time language translation is presently an unsolved problem and is solved by the proposed invention. The basic idea is to extend the proposed use described with regard to FIG. 2, by adding a language translation engine 82 and/or 84 to the text stream prior to the text to speech voice conversion. The resultant effect is for the calling or sending party to be heard in the native language of the called or receiving person. This is heard in the sending party's voice, using the voice signature. The diagram of FIG. 4 illustrates a system 80 having all the same elements of the system 40 of FIG. 2 with the addition of the language translation engines 82 and 84. In a similar fashion to the system 50 of FIG. 3, voice transcription for real time chat with language translation is illustrated in FIG. 5 in a system 100 having the same elements as the system 50 and further including language translation engines 102 and 104.

The present invention can be realized in hardware, software, or a combination of hardware and software. The present invention can also be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program or application in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A method of voice-to-text reduction for real-time messaging, comprising the steps of:
receiving a speech input at a calling party;
transcribing the speech input to a text message;
transmitting the text message as a text stream to a called party;
receiving a text message from the called party as a text stream; and
rendering the text stream at the called party and the calling party substantially in real-time.

2. The method of claim 1, wherein the method further comprises the step of sending a voice signature of the calling party to the called party.

3. The method of claim 1, wherein the method further comprises the step of maintaining a voice signature repository of the calling party for access by a called party of a voice signature of the calling party when receiving a call from the calling party.

4. The method of claim 1, wherein the step of rendering comprises the step of converting the text message at the called party to a speech output by using text-to-speech conversion.

5. The method of claim 2, wherein the step of rendering comprises the step of converting the text message at the called party to a speech output by using text-to-speech conversion in conjunction with the voice signature of the calling party.

6. The method of claim 1, wherein the method further comprises the step of translating the text message to another language to provide a translated text message.

7. The method of claim 6, wherein the step of transmitting comprises the step of transmitting the translated text message.

8. The method of claim 6, wherein the step of translating the text message occurs in at least one location selected among the calling party, the called party, and a server on a network coupled between the calling party and the called party.

9. The method of claim 2, wherein the step of rendering comprises the step of converting the text message at the called party to a speech output by using text-to-speech synthesis in conjunction with the voice signature of the calling party.

10. The method of claim 1, wherein the step of rendering comprises the step of displaying the text message in at least one location selected among the called party and the calling party.

11. A system for voice-to-text reduction for real-time messaging, comprising:
a microphone for receiving a calling party's speech input;
a text-to-speech converter for converting the calling party's speech input to a text message;
a transmitter for transmitting the text message as a text stream to a called party;
a receiver for receiving another text message from the called party; and
a rendering device for rendering text messages substantially in real-time.

12. The system of claim 11, wherein the system further comprises a translator for translating the text message into another language.

13. The system of claim 11, wherein the system further comprises a text-to speech synthesizer and the rendering device comprises a speaker for providing an audible output of the received text message from the called party.

14. The system of claim 13, wherein the text-to-speech synthesizer uses a voice signature of the called party in producing the audible output.

15. The system of claim 11, wherein the rendering device comprises a display for displaying at least one among the text message from the calling party and the text message from the called party.

16. The system of claim 11, wherein the text streams are received and transmitted over an instant messaging/chat system.

17. The system of claim 11, wherein the text streams are received and transmitted over a messaging system using data transmission protocols.

18. The system of claim 11, wherein the system further comprises a voice profile for converting text messages into alternate text messages as defined by a user such as the calling party or called party.

19. A machine-readable storage, having stored thereon a computer program having a plurality of code sections executable by a machine for causing the machine to perform the steps of:
receiving a speech input at a calling party;
transcribing the speech input to a text message;
transmitting the text message as a text stream to a called party;
receiving a text message from the called party as a text stream; and
rendering the text stream at the called party and the calling party substantially in real-time.

20. The machine-readable storage of claim 19, wherein the machine-readable storage is further programmed to, in the step of rendering, to convert the text message at the called party to a speech output by using text-to-speech conversion in conjunction with a voice signature of the calling party.
